(19) United States
(12) Patent Application Publication
(10) Pub. No.: US 2012/0005385 A1
(43) Pub. Date: Jan. 5, 2012

(54) COMMUNICATION CIRCUIT OF INTER-INTEGRATED CIRCUIT DEVICE

(75) Inventor: MING-YUAN HSU, Tu-Cheng (TW)

(73) Assignee: HON HAI PRECISION INDUSTRY CO., LTD., Tu-Cheng (TW)

(21) Appl. No.: 12/840,741

(22) Filed: Jul. 21, 2010

(30) Foreign Application Priority Data
Jun. 30, 2010 (TW) 99121363

(51) Int. Cl. G06F 13/00

(52) U.S. Cl. 710/110

(57) ABSTRACT

A communication circuit of an Inter-Integrated Circuit (I2C) includes a master device, a switch circuit, first and second groups of slave devices. Each slave device includes a data signal pin and a clock signal pin, which are connected to the switch circuit. The master device includes a data signal pin, a clock signal pin, and a general purpose input output (GPIO) pin, which are connected to the switch circuit. The GPIO pin of the master device outputs a control signal to the switch circuit, to allow communication between the first group of slave devices and the master device or communication between the second group of slave devices and the master device.

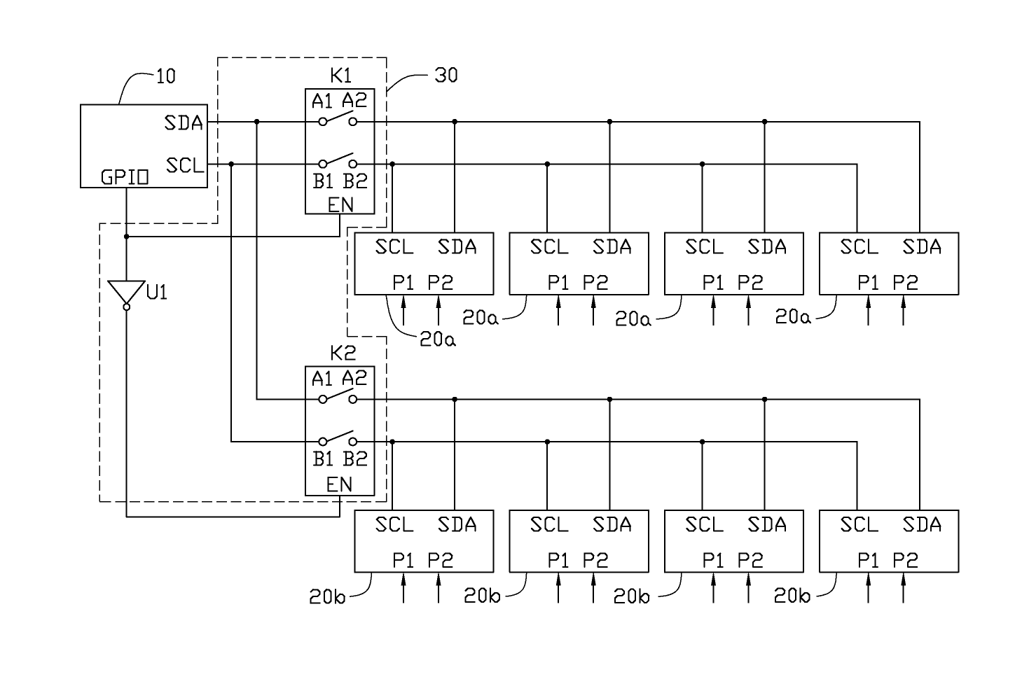

### BACKGROUND

1. Technical Field

The present disclosure relates to a communication circuit of an Inter-Integrated Circuit (I2C) device.

2. Description of Related Art

An I2C is a communication interface between a master device such as a central processing unit (CPU) of a computer and slave devices such as peripheral chips of the computer. The master device includes a data signal pin and a clock signal pin. Each slave device includes a data signal pin, a clock signal pin, and two address pins. The master device identifies each of the slave devices according to their respective address. However, the slave device with two address pins is only able to be addressed as “00”, “01”, “10”, or “11”. Thus, the master device may communicate with no more than four slave devices. Therefore, there is room for improvement in the art.

### BRIEF DESCRIPTION OF THE DRAWINGS

Many aspects of the embodiments can be better understood with reference to the following drawing. The components in the drawing are not necessarily drawn to scale, the emphasis instead being placed upon clearly illustrating the principles of the present embodiments.

The FIGURE is a circuit diagram of an exemplary embodiment of a communication circuit of I2C devices.

### DETAILED DESCRIPTION

The disclosure, including the drawing is illustrated by way of example and not by limitation. It should be noted that references to “an” or “one” embodiment in this disclosure are not necessarily to the same embodiment, and such references mean at least one.

Referring to the FIGURE, an exemplary embodiment of a communication circuit of Inter-Integrated Circuit (I2C) device includes a master device 10, a switch circuit 30, and a first group of slave devices 20a and a second group of slave devices 20b. The switch circuit 30 includes switches K1 and K2, and an inverter U1. In one embodiment, each group of the slave devices 20a, 20b includes four slave devices 20. The first group 20a is connected to the master device 10 by the switch K1. The second group 20b is connected to the master device 10 by the switch K2 and the inverter U1.

The master device 10 includes a data signal pin SDA, a clock signal pin SCL, and a general purpose input/output port (GPIO) pin. The master device 10 may be a central processing unit (CPU), a microprocessor, or a peripheral interface controller (PIC). The slave devices 20 may be peripheral chips of a computer. Each slave device 20 includes a data signal pin SDA, a clock signal pin SCL, and two address pins P1 and P2. Each of the switches K1 and K2 includes four contacts A1, A2, B1, B2, and a control terminal EN. The contact A1 is capable of connecting with the contact A2, and the contact B1 is capable of connecting with the contact B2.

The data signal pins SDA of the first group 20a are connected to the contact A2 of the switch K1. The data signal pin SDA of the master device 10 is connected to the contact A1 of the switch K1. The clock signal pins SCL of the first group 20a are connected to the contact B2 of the switch K1. The clock signal pin SCL of the master device 10 is connected to the contact B1 of the switch K1. The GPIO pin of the master device 10 is connected to the control terminal EN of the switch K1.

The data signal pins SDA of the second group 20b are connected to the contact A2 of the switch K2. The data signal pin SDA of the master device 10 is connected to the contact A1 of the switch K2. The clock signal pins SCL of the second group 20b are connected to the contact B2 of the switch K2. The clock signal pin SCL of the master device 10 is connected to the contact B1 of the switch K2. The GPIO pin of the master device 10 is connected to an input terminal of the inverter U1. An output terminal of the inverter U1 is connected to the control terminal EN of the switch K2. The switches K1 and K2 may be other type switches, which have a control terminal.

The GPIO pin of the master device 10 alternately outputs high level and low level control signals to the control terminals EN of the switches K1 and K2, to turn on or turn off the switches K1, K2. When the GPIO pin of the master device 10 outputs a high level control signal, the switch K1 is turned on and the inverter U1 converts the high level control signal to a low level control signal to turn off the switch K2. When the GPIO pin of the master device 10 outputs a low level control signal, the switch K1 is turned off, the inverter U1 converts the low level control signal to a high level control signal to turn on the switch K2. In an on state, the contact A1 connects to the contact A2 and the contact B1 connects to the contact B2. The master device 10 may communicate with the slave devices 20. In an off state, the contact A1 disconnects from the contact A2 and the contact B1 disconnects from contact B2. The master device 10 may not communicate with the slave devices 20. In other embodiments, additional groups of slave devices 20 can be added by adding a corresponding number of the GPIO pins of the master device 10.

In use, each slave device 20 includes a pair of address pins P1 and P2 to address the slave device 20 using 2-bit binary codes, “01”, “10”, “11” or “00”.

The GPIO pin of the master device 10 outputs the control signals to the control terminals EN of the switches K1 and K2, to turn on or turn off the switches K1 and K2, to communicate the master device 10 with the groups of slave devices 20a, 20b. Thus, the master device 10 may communicate with more than four slave devices, to add the number of the slave devices, which are connected to the master device. The communication circuit of I2C device is simple and economical.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A communication circuit of inter-integrated circuit (I2C) comprising:
a switch circuit;
a first and a second groups of slave devices, each group of slave devices comprising a plurality of slave devices, each of the slave devices comprising a data signal pin and a clock signal pin which are connected to the switch circuit; and
a master device comprising a data signal pin, a clock signal pin, and a general purpose input output (GPIO) pin, which connected to the switch circuit, wherein the GPIO pin of the master device outputs a control signal to the switch circuit, to communicate the first group of slave devices with the master device or communicate the second group of slave devices with the master device.

2. The communication circuit of I2C of claim 1, wherein the switch circuit comprises an inverter, a first switch, and a second switch, each of the first and the second switches comprises a control terminal, the data signal pins and the clock signal pins of the first group of slave devices are connected to the data signal pin and the clock signal pin of the master device via the first switch, the data signal pins and the clock signal pins of the second group of slave devices are connected to the data signal pin and the clock signal pin via the second switch, the GPIO pin of the master device is connected to the control terminal of the first switch and an input terminal of the inverter, an output terminal of the inverter is connected to the control terminal of the second switch.

3. The communication circuit of I2C of claim 2, wherein when the GPIO pin of the master device outputs a control signal with high level, the first switch is turned on and the inverter converts the control signal with high level to a control signal with low level to turn off the second switch, the master device communicate with the first group of slave devices; when the GPIO pin of the master device outputs a control signal with low level, the first switch is turned off, the inverter converts the control signal with low level to a control signal with high level to turn on the second switch, the master device communicate with the second group of slave devices.

4. The communication device of I2C of claim 2, wherein each of the first and the second switch comprises first to fourth contacts, the first contact is capable of connecting with the second contact, the third contact is capable of connecting with the fourth contact, the data signal pins of the first group of slave devices are connected to the second contact of the first switch, the data signal pin of the master device is connected to the first contact of the first switch, the clock signal pins of the first group of slave devices are connected to the fourth contact of the first switch, the clock signal pin of the master device is connected to the third contact of the first switch, the data signal pins of the second group of slave devices are connected to the second contact of the second switch, the data signal pin of the master device is connected to the first contact of the second switch, the clock signal pins of the second group of slave devices are connected to the fourth contact of the second switch, the clock signal pin of the master device is connected to the third contact of the second switch, when the first and the second switch is at an on state, the first contact connects to the second contact and the third contact connects to the fourth contact; when the first and the second switch is at an off state, the first contact disconnects from the second contact and the third contact disconnects from fourth contact.

5. The communication circuit of I2C of claim 1, wherein each slave device comprises a pair of address pins to address the slave devices using a 2-bit codes.

6. The communication circuit of I2C of claim 1, wherein the master device is a central processing unit, or a microprocessor, or a peripheral interface controller.

7. A communication circuit utilizing the inter-integrated circuit (I2C) protocol comprising:
a master device;
two switches connected to the master device; and
a first group of slave devices connected to one switch of the two switches and a second group of slave devices connected to the other switch of the two switches;
wherein when the master device is in communication with the first group of slave devices the one switch of the two switches is enabled and the other switch of the two switches is disabled and when the master device is in communication with the second group of slave devices the other switch of the two switches is enabled and the one other of the two switches is disabled.
